(19) United States
(12) Patent Application Publication
(10) Pub. No.: US 2015/0077641 A1
(43) Pub. Date: Mar. 19, 2015

(54) DISPLAY DEVICE, DISPLAY SYSTEM, METHOD FOR CONTROLLING DISPLAY DEVICE, PROGRAM, AND RECORDING MEDIUM

(71) Applicant: SHARP KABUSHIKI KAISHA, Osaka-shi, Osaka (JP)

(72) Inventors: Ryosuke Ohmae, Osaka-shi (JP); Fumiaki Suzuki, Osaka-shi (JP)

(73) Assignee: SHARP KABUSHIKI KAISHA, Osaka-shi, Osaka (JP)

(21) Appl. No.: 14/390,336

(22) PCT Filed: Mar. 8, 2013
(86) PCT No.: PCT/JP2013/056458

§ 371 Date: Oct. 2, 2014

(30) Foreign Application Priority Data
Apr. 23, 2012 (JP) 2012-098127

(51) Int. Cl. H04N 21/443; H04N 21/4363

(52) U.S. Cl. CPC H04N 21/4436; H04N 21/43637
USPC 348/730

(57) ABSTRACT

A display (200) includes: a wireless communication control section (215) which receives an image signal transmitted from an STB (100); and a reservation time monitoring section (204) which, in response to an instruction from a user to change a state of the display (200) to a standby state, determines, in accordance with a time remaining before a reserved viewing is started, whether or not to stop supplying electric power to the wireless communication control section (215).

### TECHNICAL FIELD

The present invention relates to a display device of a system in which a transmission device and the display device are separate.

### BACKGROUND ART

In recent years, a separate television system in which a display displaying an image and a set-top box (STB) including a tuner, for example are separate has been widespread.

For example, Patent Literature 1 discloses a wireless communication system including a plurality of source devices (STBs) and a sync device (display) which receives image data wirelessly transmitted from the plurality of source devices.

### CITATION LIST

### Patent Literature

### Patent Literature 1

Japanese Patent Application Publication, Tokukai, No. 2008-271008 (Publication Date: Nov. 6, 2008)

### SUMMARY OF INVENTION

### Technical Problem

In the case of an integrated television system (television receiver) in which a display and a set-top box are integrated, in order to reduce electric power consumption by the television system when the television system is off or in a standby state, the television system is generally operated in a state in which only a small microcomputer which is sufficient to, for example, receive a user's remote control operation and manage time.

According to a conventional separate television system which uses wireless communication, when a display is in a power off or standby state, the display receives an activation trigger by a user operation, so that the display can be activated by the activation trigger. Meanwhile, an STB of the television system needs to receive the activation trigger from the display by establishing wireless communication with the display. Therefore, the STB which is off needs to be activated by activating a wireless communication section (wireless communication control section) which is provided in the STB so as to establish wireless communication with the display. Accordingly, the conventional separate television system is generally configured such that in a state in which the STB and the display are off, the wireless communication section of the STB is active, and a wireless communication section of the display is inactive so as to save electric power.

Note here that, in a case where a viewing reservation, for example is made, the STB which receives broadcasting generally manages time information which is necessary when the viewing reservation is made. This causes the STB to have the activation trigger for activating the STB and the display at a time at which a reserved viewing is stared. However, according to the configuration of the conventional separate television system, the wireless communication section of the display is inactive so as to save electric power. This makes it impossible to transmit the activation trigger from the STB. Therefore, the wireless communication section of the display also needs to be active so that the display is activated when the viewing reservation is made.

However, when the STB and the display are in a power off or standby state, the television system in which both the wireless communication section of the STB and the wireless communication section of the display are active consumes high electric power. Therefore, when no viewing reservation is made, the television system wastefully consumes electric power in a case where the wireless communication section of the STB and the wireless communication section of the display are active.

The present invention has been made in view of the problem, and an object of the present invention is to provide a display device which consumes low electric power in a separate television system in which a transmission device and the display device are separate.

### Solution to Problem

In order to attain the object, a display device in accordance with the present invention for displaying an image, includes: a receiving section which receives an image signal transmitted from a transmission device and indicative of the image; and determining means for, in response to an instruction from a user to change a state of the display device to a standby state, determining, in accordance with a time remaining before a reserved viewing is started, whether or not to stop supplying electric power to the receiving section.

In order to attain the object, a display device of the present invention for displaying an image, includes: a receiving section which receives an image signal transmitted from a transmission device and indicative of the image; and electric power supply means for, when a state of the display device is a standby state and a time remaining before a reserved viewing is started falls below a predetermined threshold, starting supplying electric power to the receiving section.

In order to attain the object, a method of the present invention for controlling a display device for displaying an image, the display device including a receiving section which receives an image signal transmitted from a transmission device and indicative of the image, the method includes the step of: in response to an instruction from a user to change a state of the display device to a standby state, determining, in accordance with a time remaining before a reserved viewing is started, whether or not to stop supplying electric power to the receiving section.

In order to attain the object, a method of the present invention for controlling a display device for displaying an image, the display device including a receiving section which receives an image signal transmitted from a transmission device and indicative of the image, the method includes the step of: when a state of the display device is a standby state and a time remaining before a reserved viewing is started falls below a predetermined threshold, starting supplying electric power to the receiving section.

### Advantageous Effects of Invention

A display device in accordance with the present invention makes it possible to suitably reduce electric power consumption by the display device.

### BRIEF DESCRIPTION OF DRAWINGS

FIG. 1 is a block diagram illustrating a configuration of a television system.

FIG. 2 is a view showing an example of a power source mode of a television system.

FIG. 3 is a flowchart showing an example of a process in which a state of a display is changed to a power off state.

FIG. 4 is a flowchart showing another example of the process in which the state of the display is changed to the power off state.

### DESCRIPTION OF EMBODIMENTS

An embodiment of the present invention is specifically described below.

(Overview of Television System 1)

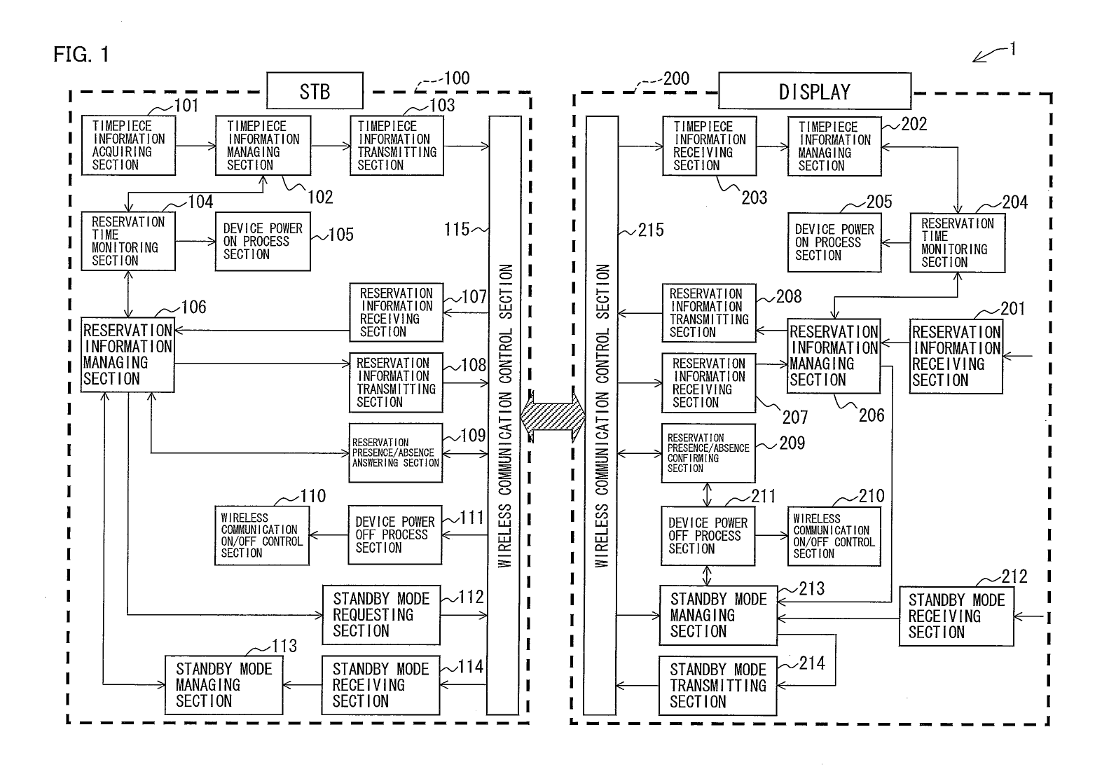

First, an overview of a television system (display system) 1 in accordance with the present invention is described with reference to FIG. 1. FIG. 1 is a block diagram illustrating a configuration of the television system 1 of the present embodiment. As illustrated in FIG. 1, the television system 1 includes an STB (transmission device, source device) 100 and a display (display device, sync device) 200.

The STB 100 and the display 200 can establish wireless communication with each other. The display 200 receives an image signal transmitted from the STB 100, and displays an image indicated by the image signal. That is, the television system 1 is a so-called separate television system. Note that the block diagram of FIG. 1 illustrates functions unique to the present invention of various functions which the STB 100 and the display 200 have. It goes without saying that the STB 100 and the display 200 may have functions which are not illustrated in FIG. 1.

(Overview of STB 100)

Next, an overview of the STB 100 is described with reference to FIG. 1. The STB 100 includes a timepiece information acquiring section 101, a timepiece information managing section 102, a timepiece information transmitting section 103, a reservation time monitoring section 104, a device power ON process section 105, a reservation information managing section 106, a reservation information receiving section 107, a reservation information transmitting section 108, a reservation presence/absence answering section 109, a wireless communication on/off control section 110, a device power OFF process section 111, a standby mode requesting section 112, a standby mode managing section 113, a standby mode receiving section 114, and a wireless communication control section 115.

The timepiece information acquiring section 101 of the STB 100 acquires timepiece information (time information) which has been externally received by an antenna (not illustrated) and is exemplified by a date, a time, and a day of the week. The timepiece information acquiring section 101 supplies the acquired timepiece information to the timepiece information managing section 102 which manages timepiece information. The timepiece information transmitting section 103 acquires the timepiece information from the timepiece information managing section 102 and transmits the acquired timepiece information via the wireless communication control section 115 to the display 200.

The reservation information managing section 106 manages reservation information. Further, the reservation information managing section 106 manages a power source mode (described later). Note here that the reservation information is information indicative of, for example, a time on which a reservation for viewing of an image (program) has been made by a user (reserved viewing start time, reserved viewing termination time, etc.), a channel, and a program.

With reference to the timepiece information acquired from the timepiece information managing section 102 and a reservation time acquired from the reservation information managing section 106, the reservation time monitoring section 104 monitors whether or not the reserved viewing start time has come. When the reserved viewing start time comes, the reservation time monitoring section 104 gives the device power ON process section 105 an instruction to turn on the STB 100. The device power ON process section 105 turns on the STB 100 in accordance with the instruction from the reservation time monitoring section 104. When the reserved viewing start time comes, the reservation time monitoring section 104 also starts transmitting, via the wireless communication control section 115 to the display 200, the image signal received by the antenna. Note that, when the reserved viewing start time comes, the reservation time monitoring section 104 may transmit, via the timepiece information managing section 102 and the timepiece information transmitting section 103 to the display 200, a notification that the reserved viewing start time has come.

The reservation information receiving section 107 receives, via the wireless communication control section 115, reservation information which has been transmitted from the display 200 and set for the display 200 by the user, for example. The reservation information receiving section 107 supplies the reservation information to the reservation information managing section 106. The reservation information transmitting section 108 transmits, via the wireless communication control section 115 to the display 200, the reservation information managed by the reservation information managing section 106.

With reference to the reservation information transmitted from the reservation information managing section 106 or the display 200, the reservation presence/absence answering section 109 confirms (determines) whether or not a reservation is present. The reservation presence/absence answering section 109 supplies a result of the confirmation via the reservation information managing section 106 to the standby mode managing section 113. The reservation presence/absence answering section 109 also transmits the result of the confirmation via the wireless communication control section 115 to the display 200.

The device power OFF process section 111 receives, via the wireless communication control section 115, a power source mode notified from the display 200, and transmits the received power source mode to the wireless communication on/off control section 110. Further, the device power OFF process section 111 changes a state of each of members of the STB 100 except the wireless communication control section 115 to a power off state (standby state) in accordance with the power source mode.

The wireless communication on/off control section 110 carries out control over whether or not to establish wireless communication. Specifically, the wireless communication on/off control section 110 which has received the power source mode from the device power OFF process section 111 carries out control over whether or not to stop supplying electric power to the wireless communication control section 115.

The standby mode requesting section 112 requests, from the display 200 via the wireless communication control section 115, a set value of a reservation standby mode which set value has been set in the display 200. The standby mode receiving section 114 receives, via the wireless communication control section 115, the set value of the reservation standby mode which set value has been transmitted from the display 200, and supplies the set value of the reservation standby mode to the standby mode managing section 113. The standby mode managing section 113 manages the set value of the reservation standby mode which set value has been received from the standby mode receiving section 114. Note that the reservation standby mode is described later.

The wireless communication control section 115 carries out control so that communication with the display 200 is established. Specifically, the wireless communication control section 115 transmits, to the display 200, the image signal received by the antenna.

(Overview of Display 200)

Next, an overview of the display 200 is described with reference to FIG. 1. The display 200 includes a reservation information receiving section 201, a timepiece information managing section 202, a timepiece information receiving section 203, a reservation time monitoring section (determining means) 204, a device power ON process section (activating means) 205, a reservation information managing section (determining means, electric power supply means, synchronizing means) 206, a reservation information receiving section 207, a reservation information transmitting section 208, a reservation presence/absence confirming section (reservation presence/absence confirming means) 209, a wireless communication on/off control section (electric power supply means) 210, a device power OFF process section 211, a standby mode receiving section 212, a standby mode managing section (standby state setting means) 213, a standby mode transmitting section 214, and a wireless communication control section (receiving section) 215.

The timepiece information receiving section 203 of the display 200 receives, via the wireless communication control section 215, time information transmitted from the STB 100, and supplies the time information to the timepiece information managing section 202 which manages timepiece information.

The reservation information managing section 206 manages reservation information. Further, the reservation information managing section 206 manages a power source mode (described later).

With reference to the timepiece information acquired from the timepiece information managing section 202 and a reservation time acquired from the reservation information managing section 206, the reservation time monitoring section 204 monitors whether or not a time remaining before a reserved viewing is started falls within a predetermined time. When the reserved viewing start time comes, the reservation time monitoring section 204 acquires, from the STB 100 via the wireless communication control section 215, the image signal transmitted from the STB 100. The reservation time monitoring section 204 which has received the image signal gives the device power ON process section 205 an instruction to turn on the display 200. The device power ON process section 205 turns on the display 200 in accordance with the instruction from the reservation time monitoring section 204. Note that, when the reserved viewing start time comes and the reservation time monitoring section 204 receives a notification that the reserved viewing start time has come, the reservation time monitoring section 204 may instruct the device power ON process section 205 to turn on the display 200.

For example, the reservation time monitoring section 204 may be configured to start monitoring the reservation time and before a state of the display 200 is changed to a standby state, transmit, to the timepiece information managing section 202, an instruction to transmit a current time. The timepiece information managing section 202 transmits the current time to the reservation time monitoring section 204 in accordance with the instruction.

The reservation information receiving section 201 receives reservation information inputted by the user by use of, for example, a remote controller, and supplies the reservation information to the reservation information managing section 206.

The reservation information receiving section 207 receives, via the wireless communication control section 215, reservation information which has been transmitted from the STB 100 and set for the STB 100 by the user, for example. The reservation information receiving section 207 supplies the reservation information to the reservation information managing section 206. The reservation information transmitting section 208 transmits, via the wireless communication control section 215 to the STB 100, the reservation information managed by the reservation information managing section 206.

With reference to the reservation information or information on presence/absence of a reservation, the reservation information or the information having been transmitted from the STB 100, the reservation presence/absence confirming section 209 confirms (determines) whether or not a reservation is present. The reservation presence/absence confirming section 209 supplies a result of the confirmation to the device power OFF process section 211. The reservation presence/absence confirming section 209 also transmits the result of the confirmation via the wireless communication control section 215 to the STB 100.

The device power OFF process section 211 transmits, to the wireless communication on/off control section 210, a power source mode supplied from the reservation information managing section 206 via the standby mode managing section 213. Further, the device power OFF process section 211 changes a state of each of members of the display 200 except the wireless communication control section 215 to a power off state (standby state) in accordance with the power source mode.

The wireless communication on/off control section 210 carries out control over whether or not to establish wireless communication. Specifically, the wireless communication on/off control section 210 which has received the power source mode from the device power OFF process section 211 carries out, in accordance with the power source mode, control over whether or not to stop supplying electric power to the wireless communication control section 215.

The standby mode receiving section 212 receives a set value of a reservation standby mode which set value has been inputted by the user by use of, for example, the remote controller, and supplies the set value of the reservation standby mode to the standby mode managing section 213.

The standby mode managing section 213 manages the set value of the reservation standby mode which set value has been received by the standby mode receiving section 212. Further, the standby mode managing section 213 supplies the managed set value of the reservation standby mode to the standby mode transmitting section 214 in accordance with the request from the STB 100 for the set value of the reservation standby mode.

The standby mode transmitting section 214 supplies, via the wireless communication control section 215 to the STB 100, the set value of the reservation standby mode which set value is managed by the standby mode managing section 213.

The wireless communication control section 215 carries out control so that communication with the STB 100 is established. Specifically, the wireless communication control section 115 receives an image signal transmitted from the STB 100, and supplies the image signal to a display section (not illustrated) which displays an image indicated by the image signal.

(Power Source Mode)

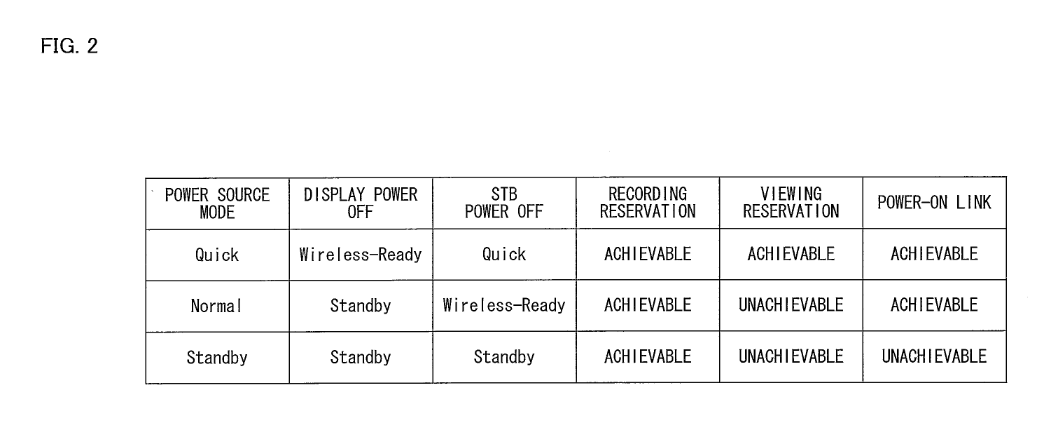

Next, a power source mode of the present embodiment is described with reference to FIG. 2. FIG. 2 is a view showing an example of a power source mode of the television system 1.

The power source mode is obtained by setting a state (power off state) in which the display 200 and the STB 100 are changed when an operation of turning off the display 200 in a power on state is carried out. A value (set value) of the power source mode is maintained (managed) by both the display 200 and the STB 100. Note that in the STB 100, the set value of the power source mode may be managed by the reservation information managing section 106 or any member other than the reservation information managing section 106. Note also that in the display 200, the set value of the power source mode may be managed by the reservation information managing section 206 or any member other than the reservation information managing section 206. Assuming that the reservation information managing section 106 and the reservation information managing section 206 each manage the set value of the power source mode, the present example gives the description.

The power source mode may be set in the display 200 or the STB 100. In order to set the power mode in the STB 100, the user selects items in a setting menu of the STB 100 in the order of “Menu”, “Setting”, “Preparation for viewing, and “Various settings”. Then, the user sets the power mode via a user interface for setting a power mode, the user interface being located in a screen displayed in response to the selection of “Various settings”.

As shown in FIG. 2, the power source mode is divided into three power source modes: “Quick”, “Normal”, and “Standby”. Note that the power source mode is not limited to these three power source modes.

The power source mode “Quick” shows that, as shown in FIG. 2, the power off state of the display 200 is “Wireless-Ready”, the power off state of the STB 100 is “Quick”, and a recording reservation, a viewing reservation, and a power-on link can be achieved.

Note here that the power off state Wireless-Ready of the display 200 shows that, when the display 200 is off, the wireless communication control section 215 is in a power on state and the other members of the display 200 are in the power off state (standby state). Note that it goes without saying that the power off state Wireless-Ready of the display 200 shows a state in which a small microcomputer which is sufficient to, for example, receive a user's remote control operation and manage time is active. The following description assumes that the above microcomputer is active in a state in which the display 200 and the STB 100 are off.

The power off state Quick of the STB 100 shows that, when the STB 100 is off, all the members of the STB 100 can be activated as soon as the user touches a power button of the STB 100 or the STB 100 receives some instruction from the user. A state in which the power-on link can be achieved shows a state in which the STB 100 and the display 200 can be turned on so as to be linked to each other. Note that the present embodiment also refers to the power source mode “Quick” as a reservation standby state.

The power source mode “Normal” shows that, as shown in FIG. 2, the power off state of the display 200 is “Standby”, the power off state of the STB 100 is “Wireless-Ready”, and the recording reservation and the power-on link can be achieved.

Note here that the power off state Standby of the display 200 shows that, when the display 200 is off, all the members of the display 200 are in the standby state. In this case, the wireless communication control section 215 is in the power off or standby state.

The power off state Wireless-Ready of the STB 100 shows that, when the STB 100 is off, the wireless communication control section 115 is in a power on state and the other members of the STB 100 are in the power off state.

Note that the present embodiment also refers to the power source mode “Normal” as a normal standby state.

The power source mode “Standby” shows that, as shown in FIG. 2, the power off state of the display 200 is “Standby”, the power off state of the STB 100 is “Standby”, and the recording reservation can be achieved.

Note here that the power off state Standby of the STB 100 shows that, when the STB 100 is off, all the members of the STB 100 are in the standby state. In this case, the wireless communication control section 115 is in the power off or standby state.

The user can set these three power source modes for the television system 1. Note that an initial value of the power off state is set for the television system 1 in advance so as to be an appropriate value in accordance with a place in which the television system 1 is to be used and/or a person for which the television system 1 is to be used.

In a case where the user sets the power source mode in the STB 100, the reservation information managing section 106 of the STB 100 manages information indicative of the set power source mode (power source mode information). The STB 100 transmits the set power source mode information to the display 200. For example, when the STB 100 and the display 200 are HDMI-connected, the STB 100 can transmit the set power source mode information by use of a CEC command, for example. Note that a method for transmitting the set power source mode information is not limited to such a method. The set power source mode information can also be transmitted by use of another communication method.

A timing at which the STB 100 and the display 200 are synchronized in terms of the power source mode is not limited to a timing at which the setting of the power source mode is completed. Alternatively, the STB 100 and the display 200 which are being connected may be constantly synchronized or may be synchronized at regular time intervals.

Note that, also in a case where the power source mode is set in the display 200, transmission of the power source mode information from the display 200 to the STB 100 allows the STB 100 and the display 200 to be synchronized as described earlier.

(Change to Power Off State)

Next, the following description discusses a process in which a state of each of the STB 100 and the display 200 of the television system 1 is changed to a power off state.

The state of the display 200 which has been turned off by, for example, a touch by the user of a power button of the display 200 is changed to a power off state in accordance with the set power source mode. For example, in a case where the power source mode of the television system 1 has been set as “Normal”, the state of the display 200 is changed to the standby state as shown in FIG. 2.

In a case where an automatic power off (off timer, for example) is set for each of the display 200 and the STB 100, and the automatic power off operates, the state of each of the display 200 and the STB 100 is changed to the power off state in accordance with the set power source mode.

The state of the STB 100 which has been turned off by, for example, the touch by the user of the power button of the STB 100 is changed to the standby state regardless of the power source mode. Note that in this case, an LED showing a power source state of the STB 100 indicates red (the power off state). Note also that a power source state of the display 200 is not changed.

When a wireless connection between the STB 100 and the display 200 is cut off, the state of the STB 100 is changed to the power off state Quick or Standby. In this case, the LED showing the power source state of the STB 100 indicates orange (the standby state). Note also that the power source state of the display 200 is not changed.

In a case where the user touches the power button of the STB 100 when the power off state of the STB 100 is Wireless-Ready, the state of the STB 100 is changed to the standby state.

(Change from Power Off State)

Next, the following description discusses a process in which the power off state of each of the STB 100 and the display 200 of the television system 1 is changed to a power on state.

When the user touches the power button of the display 200 which is in the power off state, the state of the display 200 is changed to the power on state. In this case, when the STB 100 is not in the standby state, i.e., the power off state of the STB 100 is Quick or Wireless-Ready, the state of the STB 100 is also changed to the power on state (subjected to the power-on link).

The STB 100 which is in the standby state is changed to the power on state in a case where the user touches the power button of the STB 100. In this case, the LED showing the power source state of the STB 100 indicates green (the power on state). However, the state of the STB 100 which cannot be wirelessly connected with the display 200 within a predetermined time (e.g., within one minute) is automatically changed to Wireless-Ready. In this case, the LED showing the power source state of the STB 100 indicates orange.

(Setting of Reservation Standby Mode)

Next, the following description discusses a setting of the reservation standby mode. The reservation standby mode is information indicating that the power source mode is set as “Quick” or “Normal” when a viewing reservation is made. The user can set the reservation standby mode for the television system 1.

For example, the user sets the reservation standby mode for the television system 1 via a user interface for setting on/off of the reservation standby mode, the user interface being located in a setting menu of the display 200. The standby mode receiving section 212 of the display 200 receives a set value of the reservation standby mode which set value has been inputted by the user (information indicative of on/off), and supplies the set value to the standby mode managing section (a sub-microcomputer) 213. By transmitting, to the STB 100, the set value of the reservation standby mode which set value is managed by the standby mode managing section 213, the standby mode transmitting section 214 synchronizes the STB 100 and the display 200 in terms of the reservation standby mode managed by each of the STB 100 and the display 200.

In a case where the reservation standby mode is set as “on” by the user, until a viewing reservation time comes, a state of the television system 1 is changed to the power off state of the power source mode which has been set as “Quick” or “Normal” (described earlier). Note that, in a case where the reservation standby mode is not set as “on” when the viewing reservation is made, the STB 100 and/or the display 200 may warn that the reservation standby mode is not set as “on”.

Note that the above description discusses a case where the reservation standby mode is set in the display 200. Alternatively, the reservation standby mode may be set in the STB 100.

The above description also discusses a case where the reservation standby mode is set by the user. Alternatively, the reservation standby mode may be automatically set. First, the reservation information transmitting section 108 of the STB 100 transmits, to the display 200, the reservation information managed by the reservation information managing section 106, and the reservation information receiving section 207 of the display 200 receives the reservation information. By supplying the received reservation information to the reservation information managing section 206, the reservation information receiving section 207 synchronizes the STB 100 and the display 200 in terms of the reservation information managed by each of the STB 100 and the display 200. Alternatively, the reservation information transmitting section 208 of the display 200 transmits, to the STB 100, the reservation information managed by the reservation information managing section 206, and the reservation information receiving section 107 of the STB 100 receives the reservation information. By supplying the received reservation information to the reservation information managing section 206, the reservation information receiving section 107 synchronizes the STB 100 and the display 200 in terms of the reservation information managed by each of the STB 100 and the display 200.

Then, the reservation presence/absence answering section 109 of the STB 100 determines, from the reservation information managed by the reservation information managing section 106, whether or not a viewing reservation is present. The reservation presence/absence answering section 109 transmits a result of the determination via the wireless communication control section 115 to the display 200. The reservation presence/absence confirming section 209 of the display 200 confirms, through the received result of the determination, whether or not a viewing reservation is present. Thereafter, the reservation presence/absence confirming section 209 supplies a result of the confirmation via the device power OFF process section 211 to the standby mode managing section 213.

In accordance with the result of the confirmation which result has been supplied from the reservation presence/absence confirming section 209, the standby mode managing section 213 sets the reservation standby mode as “on” in a case where a viewing reservation is present, and the standby mode managing section 213 sets the reservation standby mode as “off” in a case where no viewing reservation is present. In a case where the reservation standby mode is set as “on”, the power source mode of the television system 1 is set as “Quick” or “Normal”. By transmitting, to the STB 100, the set value of the reservation standby mode which set value is managed by the standby mode managing section 213, the standby mode transmitting section 214 synchronizes the STB 100 and the display 200 in terms of the reservation standby mode managed by each of the STB 100 and the display 200.

Note that a timing at which the reservation presence/absence answering section 109 determines whether or not a viewing reservation is present is not particularly limited. The reservation presence/absence answering section 109 may determine, when a viewing reservation is made, whether or not a viewing reservation is present. Alternatively, the reservation presence/absence answering section 109 may determine, in a background at regular time intervals while the display 200 is active, whether or not a viewing reservation is present. The reservation presence/absence answering section 109 may also determine, before the state of the display 200 is changed to the power off state after the display 200 is turned off by the user, whether or not a viewing reservation is present.

(Change to Power Off State when Reservation Standby Mode is Set)

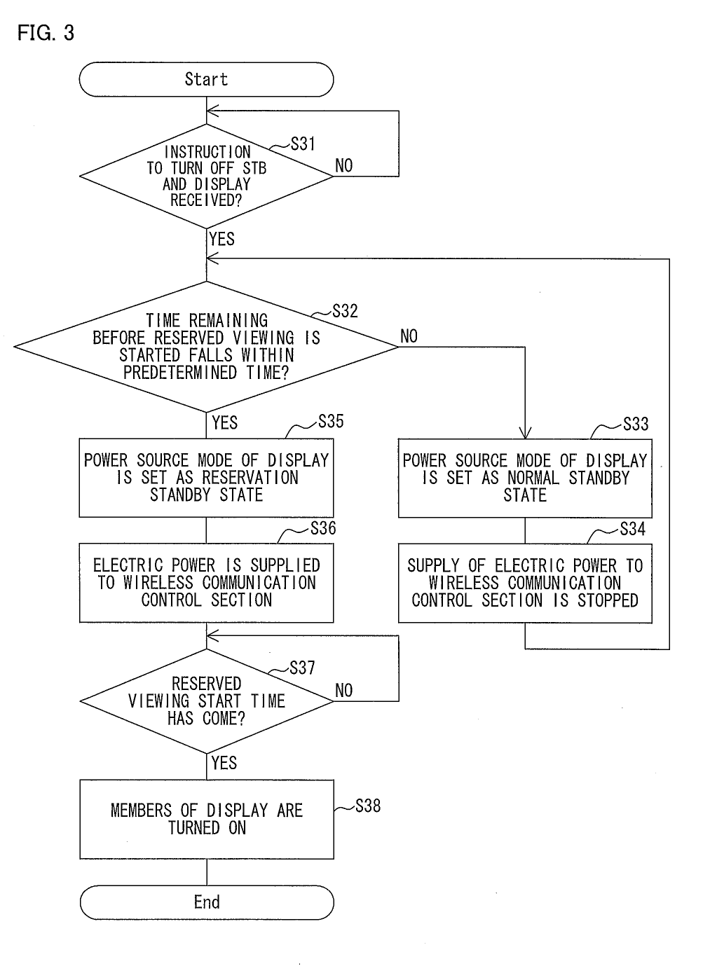

Next, the following description discusses, with reference to FIG. 3, how the state of the television system 1 is changed to the power off state when the reservation standby mode (described earlier) is set as “on”, i.e., when the information managed by the standby mode managing section 213 is information indicating that the state of the display 200 is to be changed to the standby state in which the display device can start automatically at a reservation time. FIG. 3 is a flowchart showing an example of a process in which the state of the display 200 of the television system 1 is changed to the power off state.

When the user gives an instruction to turn off the STB 100 and the display 200 (to change the state of each of the STB 100 and the display 200 to the standby state), the wireless communication control section 215 determines whether or not the instruction has been received (step S31, hereinafter referred to merely as S31). In a case where the instruction has not been received (NO at S31), the wireless communication control section 215 repeats S31. In a case where the instruction has been received (YES at S31), with reference to the timepiece information acquired from the timepiece information managing section 202 and the reservation time acquired from the reservation information managing section 206 which manages reservation information, the reservation time monitoring section 204 of the display 200 determines whether or not the time remaining before the reserved viewing is started falls within a predetermined time (S32). Similarly, the reservation time monitoring section 104 of the STB 100 also determines whether or not the time remaining before the reserved viewing is started falls within the predetermined time.

When the reservation time monitoring section 204 determines that the time remaining before the reserved viewing is started does not fall within the predetermined time (NO at S32), the reservation information managing section 206 sets the power source mode of the display 200 as “Normal” (normal standby state) (S33). Then, the reservation information managing section 206 notifies the device power OFF process section 211 via the standby mode managing section 213 that the power source mode of the display 200 has been set as the normal standby state. Further, the reservation information managing section 206 notifies the STB 100 via the reservation information transmitting section 208 that the power source mode of the display 200 has been set as the normal standby state.

Thereafter, the device power OFF process section 211 changes the state of each of the members of the display 200 except the wireless communication control section 215 to the standby state in accordance with the set power source mode. The wireless communication on/off control section 210 stops supplying electric power to the wireless communication control section 215 (S34). Note that, in a case where the supply of electric power to the wireless communication control section 215 has been stopped, the wireless communication on/off control section 210 continues to stop supplying electric power to the wireless communication control section 215.

The device power OFF process section 111 of the STB 100 changes the state of each of the members of the STB 100 except the wireless communication control section 115 to the standby state in accordance with the power source mode (“Normal”) notified from the display 200. Note that the wireless communication on/off control section 110 continues to supply electric power to the wireless communication control section 115. Note also that the device power OFF process section 111 of the STB 100 may change the state of each of the members of the STB 100 except the wireless communication control section 115 to the standby state in accordance with the power source mode set by the reservation information managing section 106 based on a result of the determination by the reservation time monitoring section 104.

Thereafter, the process returns to S32, at which the reservation time monitoring section 204 redetermines whether or not the time remaining before the reserved viewing is started falls within the predetermined time.

When the reservation time monitoring section 204 determines that the time remaining before the reserved viewing is started falls within the predetermined time (YES at S32), the reservation information managing section 206 sets the power source mode of the display 200 as “Quick” (reservation standby state) (S35). Then, the reservation information managing section 206 notifies the device power OFF process section 211 via the standby mode managing section 213 that the power source mode of the display 200 has been set as the reservation standby state. Further, the reservation information managing section 206 notifies the STB 100 via the reservation information transmitting section 208 that the power source mode of the display 200 has been set as the reservation standby state.

Note that a timing at which the reservation time monitoring section 204 determines the time remaining before the reserved viewing is started is exemplified by, but not limited to (1) a timing at which the reservation time monitoring section 204 is instructed by the user to change the state of the television system 1 to the standby state, and (2) at regular time intervals after the state of the display 200 has been changed to the normal standby state (described earlier). Alternatively, the reservation time monitoring section 204 may carry out the determination at any time.

Thereafter, the device power OFF process section 211 changes the state of each of the members of the display 200 except the wireless communication control section 215 to the standby state in accordance with the set power source mode. The wireless communication on/off control section 210 supplies electric power to the wireless communication control section 215 (S36). Note that, in a case where electric power is being supplied to the wireless communication control section 215, the wireless communication on/off control section 210 continues to supply electric power to the wireless communication control section 215.

In accordance with the power source mode (“Quick”) notified from the display 200, the device power OFF process section 111 of the STB 100 changes the state of each of the members of the STB 100 except the wireless communication control section 115 to a state (Quick state) in which the members of the STB 100 except the wireless communication control section 115 can be immediately activated. Note that the wireless communication on/off control section 110 continues to supply electric power to the wireless communication control section 115. Note also that the device power OFF process section 111 of the STB 100 may change the state of each of the members of the STB 100 except the wireless communication control section 115 to the Quick state in accordance with the power source mode set by the reservation information managing section 106 based on the result of the determination by the reservation time monitoring section 104.

Thereafter, when the reserved viewing start time comes, the reservation time monitoring section 104 starts transmitting, via the wireless communication control section 115 to the display 200, the image signal received by the antenna. Note that the reservation time monitoring section 104 may transmit, to the display 200, a notification that the reserved viewing start time has come.

The wireless communication control section 215 of the display 200 confirms whether or not the reserved viewing start time has come (S37). Specifically, the wireless communication control section 215 confirms whether or not the image signal and/or the notification that the reserved viewing start time has come have/has been received. In a case where the reserved viewing start time has not come (NO at S37), the wireless communication control section 215 repeats S37. In a case where the reserved viewing start time has come (YES at S37), the wireless communication control section 215 transmits, to the device power ON process section 205, information that the reserved viewing start time has come. Then, the device power ON process section 205 turns on the members of the display 200 (S38).

In a case where the reservation standby mode is set, a viewing reservation is registered in the television system 1. The reservation time monitoring section 204 determines whether or not the time remaining before the reserved viewing registered as the viewing reservation is started falls within a predetermined time. The reservation information managing section 206 determines the power source mode in accordance with a result of the determination. That is, the reservation information managing section 206 causes the display 200 to be in the standby state by determining, in accordance with whether or not the time remaining before the reserved viewing is started falls within the predetermined time, whether the supply of electric power to the wireless communication control section 215 is to be stopped (the state of the display 200 is to be changed to the normal standby state) or whether the supply of electric power to the wireless communication control section 215 is not to be stopped (the state of the display 200 is to be changed to the reservation standby state). Then, the state of the display 200 is changed to an electric power mode thus determined.

This prevents the supply of electric power to the wireless communication control section 215 of the display 200 from being stopped when the time remaining before the reserved viewing start is started falls within the predetermined time. Therefore, the display 200 can receive, from the STB 100, information such as information that the display 200 is to be activated when a time at which the reserved viewing is started comes. In a case where the time remaining before the reserved viewing is started does not fall within the predetermined time, it is possible to stop supplying electric power to the wireless communication control section 215 of the display 200. This makes it possible to suitably reduce electric power consumption by the display 200.

After the state of the display 200 has been changed to the normal standby state, i.e., after the supply of electric power to the wireless communication control section 215 has been stopped, the reservation time monitoring section 204 determines whether or not the time remaining before the reserved viewing registered as the viewing reservation is started falls within the predetermined time. The reservation information managing section 206 determines the power source mode in accordance with a result of the determination. That is, in accordance with whether or not the time remaining before the reserved viewing is started falls within the predetermined time, the reservation information managing section 206 determines whether the supply of electric power to the wireless communication control section 215 is not to be started (the state of the display 200 continues to be the normal standby state) or whether the supply of electric power to the wireless communication control section 215 is to be started (the state of the display 200 is to be changed to the reservation standby state).

This causes the supply of electric power to the wireless communication control section 215 of the display 200 to be stopped until the time remaining before the reserved viewing is started falls within the predetermined time. It is not until the time remaining before the reserved viewing is started falls within the predetermined time that the supply of electric power to the wireless communication control section 215 of the display 200 is started. This makes it possible to reduce electric power consumption by the display 200 also in a case where a viewing reservation is made.

[Modification]

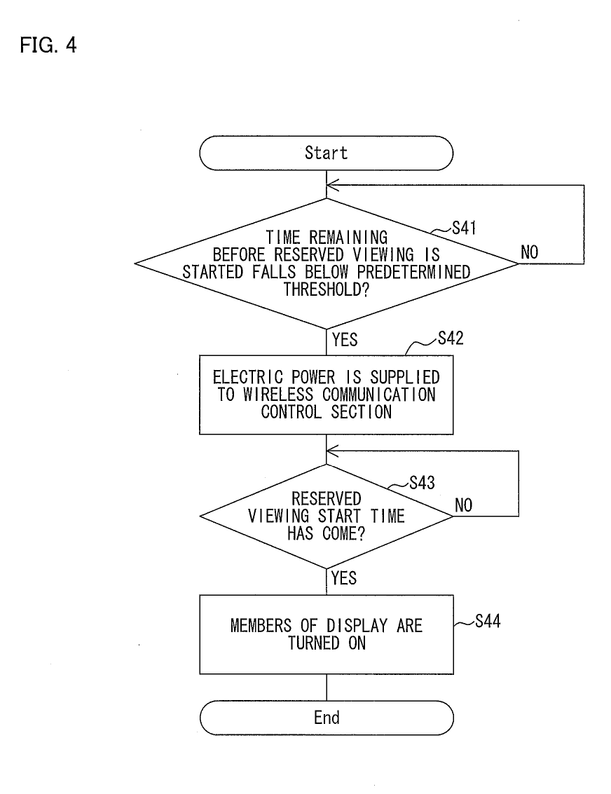

Next, the following description discusses, with reference to FIG. 4, a modification of a process in which the state of the display 200 is changed to the reservation standby state in a case where the reservation standby mode is set and the display 200 is in the standby state. FIG. 4 is a flowchart showing another example of the process in which the state of the display 200 of the television system 1 is changed to the power off state.

The present modification assumes that the display 200 is in the standby state for, for example, the reason that (1) the state of the display 200 has been changed to the normal standby state, (2) the power button of the display 200 was touched by the user when the power source mode was “Normal” or “Standby” mode, or (3) an off timer operated when the power source mode was “Normal” or “Standby” mode. In this case, the supply of electric power to the wireless communication control section 215 of the display 200 has also been stopped.

The reservation information managing section 206 of the display 200 determines, by use of, for example, a counter, whether or not the time remaining before the reserved viewing is started falls below a predetermined threshold (S41). In this case, the reservation information managing section 206 instructs the device power ON process section 205, at regular time intervals, to activate the members of the display 200 including the wireless communication control section 215 in the background. In a case where the device power ON process section 205 temporarily activates the members of the display 200 in the background at regular time intervals, the reservation information managing section 206 can receive program information such as a start time changed by, for example, a change in program schedule of a program reserved for viewing. Further, the reservation information managing section 206 can receive the timepiece information via the timepiece information managing section 202. This makes it possible to correct a time lag occurring in the counter.

The reservation information managing section 206 which has received the timepiece information and the program information on the program reserved for viewing instructs the device power OFF process section 211 via the standby mode managing section 213 to change the state of the display 200 to the standby state.

Note that, in a case where information of the counter has been lost by the change in state of the display 200 to the standby state, the reservation information managing section 206 may synchronize the counter with the display 200 by reinstructing the device power ON process section 205 to activate the display 200 in the background.

In a case where the time remaining before the reserved viewing is started does not fall below the predetermined threshold (NO at S41), the reservation information managing section 206 repeats S41.

When the time remaining before the reserved viewing is started falls below the predetermined threshold (YES at S41), the reservation information managing section 206 gives the wireless communication on/off control section 210 an instruction to supply electric power to the wireless communication control section 215. Then, in accordance with the instruction, the wireless communication on/off control section 210 starts supplying electric power to the wireless communication control section 215 (S42).

Thereafter, when the reserved viewing start time comes, the reservation time monitoring section 104 starts transmitting, via the wireless communication control section 115 to the display 200, the image signal received by the antenna. Note that the reservation time monitoring section 104 may transmit, to the display 200, a notification that the reserved viewing start time has come.

The wireless communication control section 215 of the display 200 confirms whether or not the reserved viewing start time has come (S43). Specifically, the wireless communication control section 215 confirms whether or not the image signal and/or the notification that the reserved viewing start time has come have/has been received. In a case where the reserved viewing start time has not come (NO at S43), the wireless communication control section 215 repeats S43. In a case where the reserved viewing start time has come (YES at S43), the wireless communication control section 215 transmits, to the device power ON process section 205, information that the reserved viewing start time has come. Then, the device power ON process section 205 turns on the members of the display 200 (S44).

As described earlier, when the display 200 is in the standby state and the time remaining before the reserved viewing is started falls below the predetermined threshold, electric power is supplied to the wireless communication control section 215 of the display 200. This makes it possible to more suitably reduce electric power consumption by the display 200.

Note that the image signal recited in the claims is not limited to image signals which are supplied from broadcasting sources such as terrestrial digital broadcasting, CS broadcasting, and BS broadcasting. The image signal recited in the claims is also exemplified by image signals which are supplied from communication sources such as IPTV and VOD, medium sources such as a hard disk drive and an optical disc drive, and application sources such as a web browser and a USB application (an application which plays back content stored in a USB memory). The image signal recited in the claims is not limited to an image signal indicative of a moving image, but may also be an image signal indicative of a still image. The image signal recited in the claims may also be an image signal indicative of a UI (user interface) such as an image signal which is supplied from an application source.

The present embodiment discusses an example in which the STB 100 and the display 200 establish wireless communication. Alternatively, the STB 100 and the display 200 may be configured to establish communication by, for example, being HDMI-connected.

The present invention is not limited to the description of the embodiments above, but may be altered by a skilled person within the scope of the claims. An embodiment based on a proper combination of technical means disclosed in different embodiments is encompassed in the technical scope of the present invention.

[Software Implementation Example]

Finally, control blocks of the television system 1 may be realized by a logic circuit (hardware) provided in an integrated circuit (IC chip) or may be realized by software as executed by a CPU (Central Processing Unit).

In the latter case, the television system 1 includes: a CPU that executes instructions of a program realizing the foregoing functions; memory devices (storage media) including a ROM (Read Only Memory) storing the program, a RAM (Random Access Memory) that develops the program in executable form, and a memory storing the program and various kinds of data. The object of the present invention can also be achieved by making available to the television system 1 a storage medium computer-readably storing program codes (an executable program, an intermediate code program, and a source program) of a control program of the television system 1 which control program is software realizing the foregoing functions, and by causing a computer (or CPU or MPU) of the television system 1 to retrieve and execute the program codes stored in the storage medium.

The storage medium may be, for example, a tape, such as a magnetic tape or a cassette tape; a magnetic disk, such as a floppy (Registered Trademark) disk or a hard disk, or an optical disc, such as CD-ROM/MO/MD/DVD/CD-R; a card, such as an IC card (including a memory card) or an optical card; a semiconductor memory, such as a mask ROM/EPROM/EEPROM (Registered Trademark)/flash ROM; or a logic circuit, such as PLD (Programmable logic device) or FPGA (Field Programmable Gate Array).

The program codes may be made available over a communications network by arranging the television system 1 to be connectable to the communications network. Such a communications network is not particularly limited provided that the communications network can transfer the program codes. The communications network may be, for example, the Internet, an intranet, extranet, LAN, ISDN, VAN, CATV communications network, virtual dedicated network (Virtual Private Network), telephone line network, mobile communications network, or satellite communications network. A transfer medium which makes up the communications network is not limited to a transfer medium of a specific structure or type provided that the transfer medium can transfer the program codes. The transfer medium may be, for example, a wired system, such as IEEE 1394, a USB, an electric power line, a cable TV line, a telephone line, or an ADSL (Asymmetric Digital Subscriber Line) line; or a wireless system, such as infrared radiation (IrDA, remote control), Bluetooth (Registered Trademark), IEEE 802.11 wireless, HDR (High Data Rate), NFC (Near Field Communication), DLNA (Digital Living Network Alliance), a mobile telephone network, a satellite line, or a terrestrial digital network. The present invention encompasses a computer data signal in which the program codes are embodied electronically and which is embedded in a carrier wave.

### CONCLUSION

As described earlier, a display device in accordance with an embodiment of the present invention for displaying an image, includes: a receiving section which receives an image signal transmitted from a transmission device and indicative of the image; and determining means for, in response to an instruction from a user to change a state of the display device to a standby state, determining, in accordance with a time remaining before a reserved viewing is started, whether or not to stop supplying electric power to the receiving section.

According to the configuration, in response to the instruction from the user to change the state of the display device to the standby state, the determining means determines whether or not the time remaining before the reserved viewing is started falls within a predetermined time. In a case where the time remaining before the reserved viewing is started is longer than the predetermined time, the determining means determines that the supply of electric power to the receiving section is to be stopped. In a case where the time remaining before the reserved viewing is started falls within the predetermined time, the determining means determines that the supply of electric power to the receiving section is not to be stopped. Then, the state of the display device is changed to the standby state in accordance with the determination by the determining means.

This prevents the supply of electric power to the receiving section of the display device from being stopped when the time remaining before the reserved viewing is started falls within the predetermined time. Therefore, the display device can receive, from the transmission device, information such as information that the display device is to be activated when a time at which the reserved viewing is started comes. In a case where the time remaining before the reserved viewing is started does not fall within the predetermined time, it is possible to stop supplying electric power to the receiving section of the display device. This makes it possible to suitably reduce electric power consumption by the display device.

The display device of an embodiment of the present invention is preferably configured such that, after stopping supplying electric power to the receiving section, the determining means determines, in accordance with the time remaining before the reserved viewing is started, whether or not to start supplying electric power to the receiving section.

This causes the supply of electric power to the receiving section of the display device to be stopped until the time remaining before the reserved viewing is started falls within the predetermined time. It is not until the time remaining before the reserved viewing is started falls within the predetermined time that the supply of electric power to the receiving section of the display device is started. This makes it possible to more suitably reduce electric power consumption by the display device.

The display device of an embodiment of the present invention is preferably configured to further include: standby state setting means for, in response to the instruction from the user to change the state of the display device to the standby state, setting whether or not to change the state of the display device to the standby state, when the state of the display device is set, by the standby state setting means, to be changed to the standby state, the determining means determining whether or not to stop supplying electric power to the receiving section.

This makes it possible to suitably reduce electric power consumption by the display device without changing the state of the display device to the standby state at a timing which is not intended by the user.

The display device of an embodiment of the present invention is preferably configured to further include: reservation presence/absence confirming means for confirming whether or not the reserved viewing is present, in a case where it has been confirmed by the reservation presence/absence confirming means that the reserved viewing is present, the standby state setting means setting the state of the display device to be changed to the standby state in which the display device can start automatically at a reservation time.

According to this, in a case where the reserved viewing is present, it is possible to set the state of the display device to be changed to the standby state in which the display device can start automatically at a reservation time. This makes it possible to more suitably reduce electric power consumption by the display device.

A display device in accordance with an embodiment of the present invention for displaying an image, includes: a receiving section which receives an image signal transmitted from a transmission device and indicative of the image; and electric power supply means for, when a state of the display device is a standby state and a time remaining before a reserved viewing is started falls below a predetermined threshold, starting supplying electric power to the receiving section.

According to the configuration, when the state of the display device is the standby state and the time remaining before the reserved viewing is started falls below the predetermined threshold, electric power is supplied to the receiving section of the display device. Therefore, when the time remaining before the reserved viewing is started falls below the predetermined threshold, the display device can receive, from the transmission device, information such as information that the display device is to be activated when a time at which the reserved viewing is started comes. Meanwhile, when the time remaining before the reserved viewing is started does not fall below the predetermined threshold, no electric power is supplied to the receiving section of the display device. This makes it possible to suitably reduce electric power consumption by the display device.

The display device of an embodiment of the present invention is preferably configured to further include: synchronizing means for temporarily activating the display device in a background at regular time intervals, and synchronizing with the transmission device in terms of a time at which the reserved viewing is started, the synchronizing means changing the state of the display device to the standby state after synchronizing with the transmission device in terms of the time at which the reserved viewing is started.

According to the configuration, in a case where the display device synchronizes with the transmission device at regular time intervals in terms of the time at which the reserved viewing is started, even if the time at which the reserved viewing is started is changed by, for example, a change in program schedule of a program reserved by the user for viewing, the electric power supply means supplies no electric power to the receiving section until a time remaining before the program reserved by the user for viewing is started falls below the predetermined threshold. This makes it possible to more suitably reduce electric power consumption by the display device.

The display device of an embodiment of the present invention is preferably configured such that: the receiving section receives, from the transmission device, information indicating that a reserved viewing start time has come,

the display device further including: activating means for activating the display device when the receiving section receives the information.

The information indicating that a reserved viewing start time has come, the information being transmitted from the transmission device which receives the image signal, is, for example, a notification that a reserved viewing start time has come or an image signal indicative of a program reserved for viewing.

In a case where the receiving section has received such information from the transmission device, even if the time at which the reserved viewing is started is changed by, for example, the change in program schedule of the program reserved by the user for viewing, the display device can be in the standby state until the program reserved by the user for viewing is started. This makes it possible to more suitably reduce electric power consumption by the display device.

A method of an embodiment of the present invention for controlling a display device for displaying an image, the display device including a receiving section which receives an image signal transmitted from a transmission device and indicative of the image, the method includes the step of: in response to an instruction from a user to change a state of the display device to a standby state, determining, in accordance with a time remaining before a reserved viewing is started, whether or not to stop supplying electric power to the receiving section.

The configuration yields an effect similar to that yielded by a display device in accordance with the present invention.

A method of an embodiment of the present invention for controlling a display device for displaying an image, the display device including a receiving section which receives an image signal transmitted from a transmission device and indicative of the image, the method includes the step of: when a state of the display device is a standby state and a time remaining before a reserved viewing is started falls below a predetermined threshold, starting supplying electric power to the receiving section.

The configuration yields an effect similar to that yielded by a display device in accordance with the present invention.

Note that a system including: a transmission device which transmits an image signal; and a display device mentioned above also falls under the category of the present invention.

A program for causing a computer to operate as a display device mentioned above, the program causing the computer to function as each means of the display device, and a computer-readable storage medium storing therein the program also fall under the category of the present invention.

### INDUSTRIAL APPLICABILITY

The present invention is suitably usable for a separate television system in which an STB and a display are separate.

### REFERENCE SIGNS LIST

1 Television system (display system)
100 STB (transmission device, source device)
101 Timepiece information acquiring section
102 Timepiece information managing section
103 Timepiece information transmitting section
104 Reservation time monitoring section
105 Device power ON process section
106 Reservation information managing section
107 Reservation information receiving section
108 Reservation information transmitting section
109 Reservation presence/absence answering section
110 Wireless communication on/off control section
111 Device power OFF process section
112 Standby mode requesting section
113 Standby mode managing section
114 Standby mode receiving section
115 Wireless communication control section
200 Display (reception device, sync device)
201 Reservation information receiving section
202 Timepiece information managing section
203 Timepiece information receiving section
204 Reservation time monitoring section (determining means)
205 Device power ON process section (activating means)
206 Reservation information managing section (determining means, electric power supply means, synchronizing means)
207 Reservation information receiving section
208 Reservation information transmitting section
209 Reservation presence/absence confirming section (reservation presence/absence confirming means)
210 Wireless communication on/off control section (electric power supply means)
211 Device power OFF process section
212 Standby mode receiving section
213 Standby mode managing section (standby state setting means)
214 Standby mode transmitting section
215 Wireless communication control section (receiving section)

1-12. (canceled)

13. A display device for displaying an image, comprising:
a receiving section which receives an image signal transmitted from a transmission device and indicative of the image, the transmission device externally receiving the image signal and then transmitting the image signal to the receiving section,
together with the display device, the transmission device constituting a display system, and
the display device including determining means for, in response to an instruction from a user to change a state of the display device to a standby state, determining, in accordance with a time remaining before a reserved viewing is started, whether or not to stop supplying electric power to the receiving section.

14. The display device as set forth in claim 13, wherein, after stopping supplying electric power to the receiving section, the determining means determines, in accordance with the time remaining before the reserved viewing is started, whether or not to start supplying electric power to the receiving section.

15. The display device as set forth in claim 13, further comprising:
standby state setting means for, in response to the instruction from the user to change the state of the display device to the standby state, setting whether or not to change the state of the display device to the standby state,
when the state of the display device is set, by the standby state setting means, to be changed to the standby state, the determining means determining whether or not to stop supplying electric power to the receiving section.

16. The display device as set forth in claim 15, further comprising:
reservation presence/absence confirming means for confirming whether or not the reserved viewing is present,
in a case where it has been confirmed by the reservation presence/absence confirming means that the reserved viewing is present, the standby state setting means setting the state of the display device to be changed to the standby state in which the display device can start automatically at a reservation time.

17. A display device for displaying an image, comprising:
a receiving section which receives an image signal transmitted from a transmission device and indicative of the image; and
electric power supply means for, when a state of the display device is a standby state and a time remaining before a reserved viewing is started falls below a predetermined threshold, starting supplying electric power to the receiving section.

18. The display device as set forth in claim 17, further comprising:
synchronizing means for temporarily activating the display device in a background at regular time intervals, and synchronizing with the transmission device in terms of a time at which the reserved viewing is started,
the synchronizing means changing the state of the display device to the standby state after synchronizing with the transmission device in terms of the time at which the reserved viewing is started.

19. The display device as set forth in claim 13, wherein:
the receiving section receives, from the transmission device, information indicating that a reserved viewing start time has come,
said display device further comprising:
activating means for activating the display device when the receiving section receives the information.

20. A display system comprising:
a transmission device which transmits an image signal; and
a display device recited in claim 13.

21. A method for controlling a display device for displaying an image, the display device including a receiving section which receives an image signal transmitted from a transmission device and indicative of the image,
said method comprising the step of:
in response to an instruction from a user to change a state of the display device to a standby state, determining, in accordance with a time remaining before a reserved viewing is started, whether or not to stop supplying electric power to the receiving section.

22. A non-transitory computer-readable storage medium storing therein a program for causing a computer to operate as a display device recited in claim 13, the program causing the computer to function as each means of the display device.
